(19) United States
(12) Patent Application Publication
(10) Pub. No.: US 2017/0073077 A1
(43) Pub. Date: Mar. 16, 2017

(54) METHOD AND APPARATUS FOR A HOMOGENEOUS THERMOPLASTIC ARM REST SUPPORT

(71) Applicant: Reliant Worldwide Plastics, LLC, Plano, TX (US)

(72) Inventor: William H. Maslakow, Lewisville, TX (US)

(73) Assignee: Reliant Worldwide Plastics, LLC, Plano, TX (US)

(21) Appl. No.: 15/261,138

(22) Filed: Sep. 9, 2016

Related U.S. Application Data
(60) Provisional application No. 62/217,786, filed on Sep. 11, 2015.

(51) Int. Cl. B64D 11/06; B29C 45/14

(52) U.S. Cl. CPC B64D 11/0646; B29C 45/14311; B29C 45/14631; B29C 45/14786; B29C 2045/14327; B29K 2101/12

(57) ABSTRACT

An arm rest support includes a support element. A reinforcing element is disposed on the support element. The support element is chemically compatible with the reinforcing element. A homogeneous chemical bond is formed between the support element and the reinforcing element.

### CROSS-REFERENCE TO RELATED APPLICATIONS

This patent application claims priority to and incorporates by reference for any purpose the entire disclosure of U.S. Provisional Patent Application No. 62/217,786, filed on Sep. 11, 2015.

### BACKGROUND

Field of the Invention

The present application relates generally to commercial aircraft seats and more particular, but not by way of limitation, to a homogeneous thermoplastic arm rest support formed via homogeneous chemical bonding of thermoplastic components.

History of the Related Art

In the commercial aircraft industry, weight and safety are important issues. For example, a weight savings on structural components such as arm rest supports can add up to significant weight savings for the aircraft as a whole due, in no small part to the large number of seats. The weight saving in turn may reduce then fuel expenditure and provide a cost savings. In the specific case of arm rest supports, any such weight reduction must not adversely affect strength. Typically, governmental rules and regulations and industry structural performance requirements specify strength requirements for aircraft elements, and at the very least, strength issues may impact durability and expected lifespan of an element, such as an arm rest support. Cost is also a driving factor in the commercial aircraft industry, so low-cost manufacturing techniques may be important as well. Disclosed embodiments herein relate to improved arm rest support embodiments that may address one or more of these issues.

### SUMMARY

The present application relates generally to commercial aircraft seats and more particular, but not by way of limitation, to a homogeneous thermoplastic arm rest support formed via homogeneous chemical bonding of thermoplastic components. In one aspect, the present invention relates to an arm rest support. An arm rest support includes a thermoplastic support element. The thermoplastic support element includes a plurality of apertures formed therethrough. A reinforcing element is disposed on a generally planar surface of the thermoplastic support element. The reinforcing element is chemically compatible with the support element and surrounds a perimeter of the thermoplastic support element. The plurality of apertures allow thermoplastic material to flow therethrough thereby facilitating creation of a homogeneous chemical bond between the support element and the reinforcing element.

In another aspect, the present invention relates to a method of forming a thermoplastic arm rest support. A method of forming a thermoplastic arm rest support includes forming a thermoplastic support element. The thermoplastic support element has a plurality of apertures formed therein. The thermoplastic support element is arranged in a mold. A reinforcing element is molded to a generally planar surface of the thermoplastic support element. The method also includes flowing thermoplastic material through the plurality of apertures and creating a homogeneous chemical bond between the thermoplastic support element and the reinforcing element.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is an exploded perspective view of an arm rest support having a full-length support element according to an exemplary embodiment;

FIG. 2 is a perspective view of the arm rest support of FIG. 1 according to an exemplary embodiment;

FIG. 3 is an exploded perspective view of an arm rest support having a partial-length support element according to an exemplary embodiment;

FIG. 4 is a perspective view of the arm rest support of FIG. 3 according to an exemplary embodiment;

FIG. 5 is an exploded perspective view of an arm rest support having a homogenous failure module (“HFM”) incorporated therewith according to an exemplary embodiment;

FIG. 6 is a perspective view of the arm rest support of FIG. 5;

FIG. 7 is a partial perspective view of a thermoplastic support element with an integral thermoplastic positioning system embedded therein according to an exemplary embodiment; and

FIG. 8 is a flow diagram of a process for forming an arm rest support according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

Some disclosed embodiments may generally relate to an extension of concepts of embodiments previously disclosed in related provisional U.S. patent application 61/711,567 and related U.S. non-provisional patent application Ser. No. 14/048,840, entitled Thermoplastic Injection Molded Element with Integral Thermoplastic Positioning System for Reinforced Composite Structures, filed respectively Oct. 9, 2012 and Oct. 8, 2013, which are co-owned and hereby incorporated by reference to the extent they do not contradict the express disclosure herein.

Arm rest support embodiments are, in some embodiments, comprised of thermally formed and consolidated thermoplastic encapsulated unidirectional or weave carbon or glass reinforcing fiber composite configured to meet the minimum load requirement of the arm rest support. Such arm rest support embodiments may be further comprised of thermoplastic injection molded carbon or glass chopped fiber-reinforced reinforcing elements which are injection molded and homogenously attached to the thermoplastic encapsulated unidirectional or weave carbon or glass reinforced composite structure.

In some embodiments, the integral thermoplastic support element may further be comprised of application-specific support rib structures, mounting features and threaded insert mounting bosses. Such support element embodiments may further be comprised of integral injection molded thermoplastic positioning system spire elements that provide repeatable positioning of said support element to an injection mold tool cavity during the injection molding process, providing a repeatable consistent positional placement of said thermoplastic encapsulated reinforced fiber composite integral to the arm rest support thereby ensuring consistent load requirement performance.

Furthermore, in some embodiments, the integral thermoplastic support element embodiments may further comprise a plurality of apertures provided through at least one wall section of the thermoplastic encapsulated reinforced fiber composite. Such apertures provide a pathway for thermoplastic resin material of the reinforcing elements to flow through and about the thermoplastic reinforced composite to provide additional connective homogenous elements.

Such thermoplastic arm rest support embodiments may comply with FAR 25.853 and OSU55/55, with integral formed thermoplastic encapsulated uni-directional or weave carbon or glass reinforced composite element integrated with a thermoplastic injection molded carbon or glass chopped fiber -reinforced support element and integral thermoplastic positioning spire elements and a thermoplastic injection molded reinforcing element of the arm rest support providing a high strength-to-weight ratio assembly that meets the minimum performance requirements of the application.

Some disclosed embodiments may be comprised of chemical and molecular compatible thermoplastics resins throughout the assembly, creating an infinite number of homogenous connective attachments that provide additional consistent strength, dimensional stability and rigidity.

Some disclosed embodiments may provide increased mechanical load bearing capabilities provided by the integral formed thermoplastic carbon or glass reinforced composite element with the integral injection molded carbon or glass fiber reinforced thermoplastic support element by the infinite number of homogeneous connective interfaces.

In some embodiments, the integral formed thermoplastic encapsulated carbon or glass reinforced composite element may comprise multiple weave patterns, multiple layers and layer orientations to provide the optimum performance for the requirement load application.

Disclosed embodiments generally relate to arm rest supports, for example to be used with seat assemblies for aircraft. Typically, disclosed elements of a support structure within an arm rest support may comprise one or more layers of composite material. For example, the elements of the support structure might comprise a composite element having one or more layers of composite material. Each layer of composite material typically has reinforcing fibers such as, for example, a weave of reinforcing fibers located internally, with thermoplastic surrounding it. In a typical embodiment, the composite material typically would only have reinforcing fibers located internally, for example in a central plane. When multiple layers of composite material form the elements of assembly, the multiple layers of composite typically would be thermally or homogeneously joined or otherwise consolidated together to form a unitary structure with homogeneous connective interface throughout. Typically, the one or more layers of composite material may be shaped into the form of the elements of the arm rest support, configured to attach to an airline seat assembly.

In some embodiments, one or more of the elements of the arm rest support might be injection molded onto the composite material, and since the elements typically would be formed of the same thermoplastic as the composite material, the elements typically would be thermally formed and homogeneously connected to the composite material. Specific embodiments related to the figures will be discussed in more detail below.

For example, the composite material typically may comprise an array of reinforcing fibers such as, for example, carbon, graphite, glass, or aramid. The reinforcing fibers typically include carbon microscopic crystals aligned parallel to the longitudinal axis of the carbon fibers such as, for example, aligned in a precise orientation, and a thermoplastic material located about the array of reinforcing fibers. The array of fibers may be a weave pattern such as, for example, a five harness satin weave, in some embodiments, while in other embodiments the array of fibers may be aligned uni-directionally in a parallel linear pattern. In some embodiments, the composite might be provided in pre-defined or pre-formed solid three dimensional geometries, such as a solid sheet, which can then be shaped according to the needs of the specific element such as, for example, by heat forming or cutting. Since such a composite material typically may be a rigid solid at room temperature and only softens sufficiently to allow shaping such as bending or twisting at elevated temperatures, there would typically be no need for an external frame to hold the composite in the desired shape and/or position while forming encapsulating thermoplastic about the composite using injection molding in order to form any desired additional element. In other words, once the composite sheet material is shaped as desired for the particular support structure and has cooled to room temperature, it is a rigid solid that will independently hold the shape in question, and should not need any framework to hold its shape within the mold for forming thermoplastic elements onto the composite.

In other embodiments, the composite material may be formed by layering thermoplastic film and reinforcing fiber cloth or weave, which would then be consolidated such as, for example, via heat or compression into a unitary composite material with reinforcing fibers located between two thermoplastic layers. For example, each composite material layer might comprise two thermoplastic film layers sandwiching or surrounding a layer of reinforcing fiber. The one or more layers of composite might then be placed on a press mold for the shape of an arm rest support structure, with the press mold then being used to consolidate the one or more layers of composite, thereby forming the composite support structure for use with an arm rest support.

The array of fibers of the composite material is typically located near the center of the composite material, with thermoplastic material located atop and beneath the array of fibers. In other words, a single layer or single ply of the composite material would typically have all of the reinforcing fibers located in a single/central plane, with the rest of the thickness of the composite material being formed of thermoplastic material; and multi-layer or multi-ply composite elements would typically have several layers or plies, each comprised of reinforcing fibers located in a single/central plane, with the rest of the thickness being formed of thermoplastic material. The centrally located reinforcement of each adjoining layer or ply may be independent to the adjacent adjoining layer or ply. Each centrally located reinforcement layer or ply might have an equal volume of thermoplastic located atop and beneath the array of fibers, providing a consistent dimensional separation between the reinforcing array of fibers. Regardless, the composite typically might provide approximately consistent fiber distribution throughout the element, so that it can provide precise and consistent/reproducible structural and/or mechanical support.

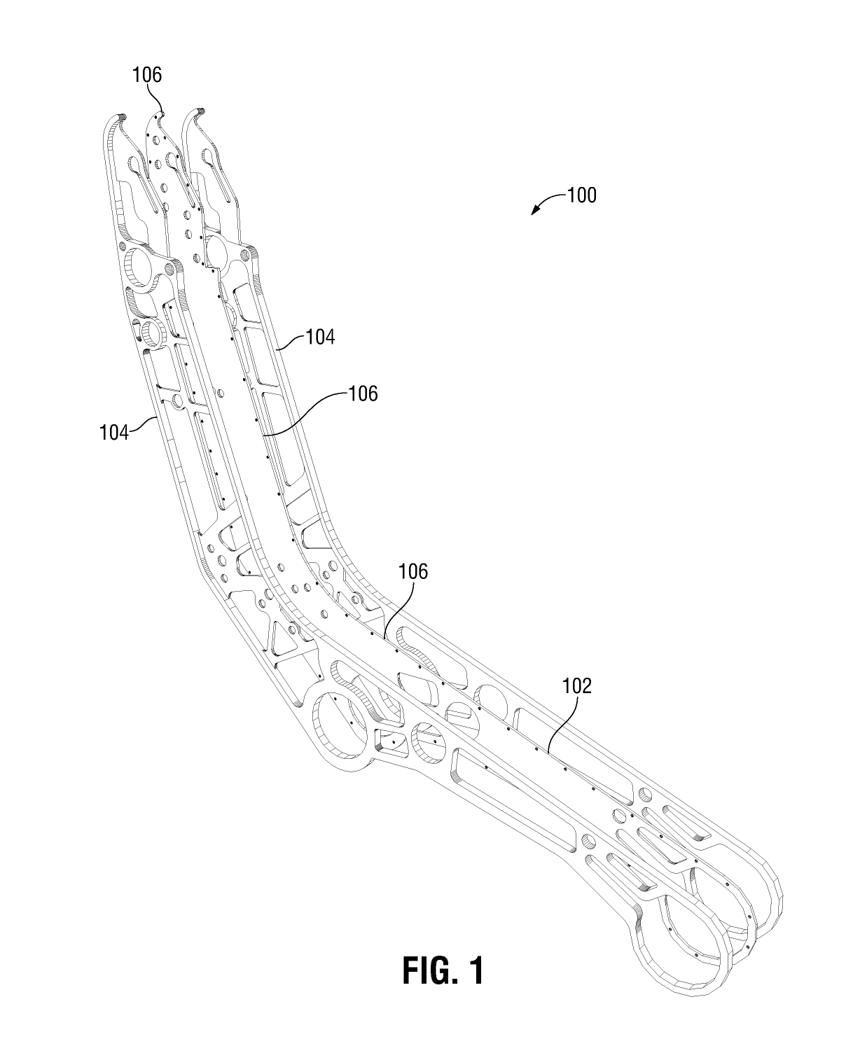

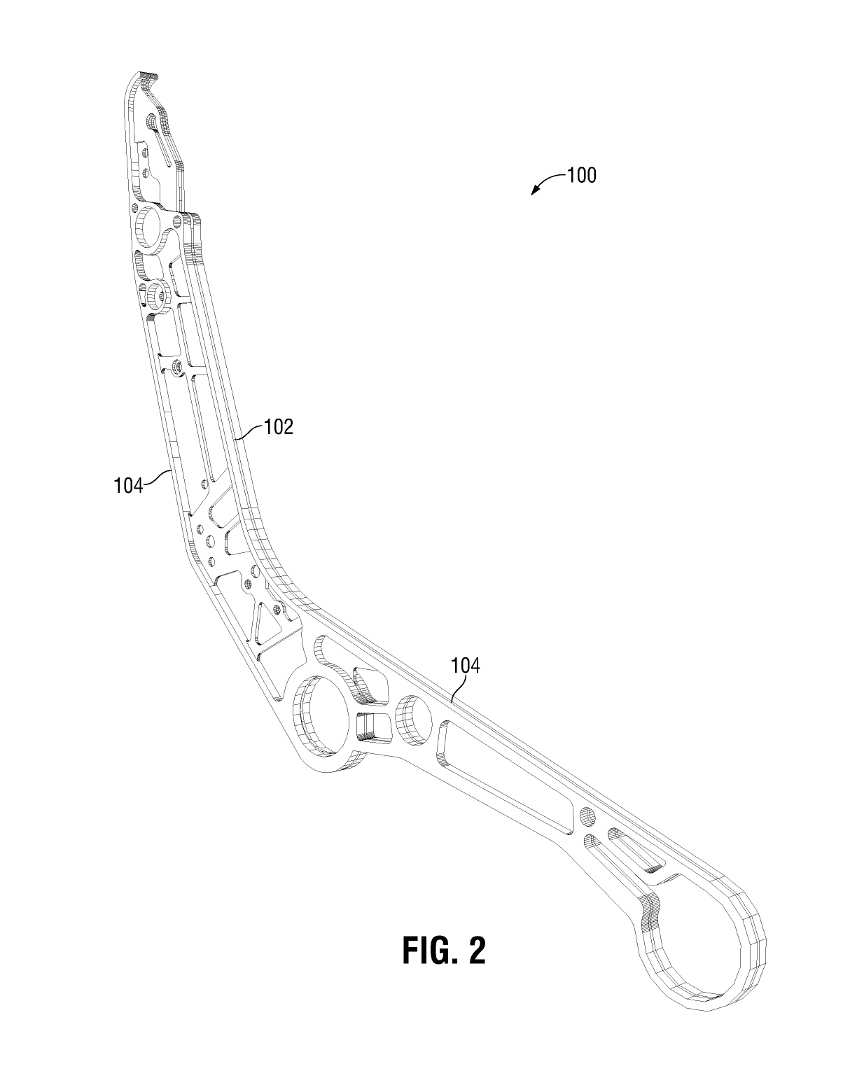

FIG. 1 is an exploded perspective view of an arm rest support 100 having a full-length support element 102. FIG. 2 is a perspective view of the arm rest support 100. Referring to FIGS. 1-2 collectively, the arm rest support 100 includes a centrally-disposed support element 102 integrally formed with a plurality of reinforcing elements 104 coupled thereto. In a typical embodiment, the support element 102 includes a carbon or glass reinforced thermoplastic laminate material such as, for example, a thermally-consolidated composite material forming a composite structure. In some embodiments, the support element 102 may be formed of the carbon reinforced thermoplastic material such as, for example, composite material and the reinforcing elements 104 may be molded onto the support element 102. In a typical embodiment, the reinforcing elements 104 comprise a thermoplastic material with a resin compatible with the resin of the support element 102. Typically, the thermoplastic of the reinforcing elements 104 would be the same as the thermoplastic of the composite of the support element 102 so that molding results in chemically-compatible homogenous connections.

Still referring to FIGS. 1-2 in various embodiments, the support element 102 may be substantially flat and comprise a generally planar shape. In other embodiments, the support element 102 may include a form such as, for example, a corrugation that is generally parallel to the long axis of the support element 102 to enhance the strength of the support element 102. A plurality of apertures 106 are formed in the support element 102. The apertures 106 are illustrated in FIG. 1 as being disposed along a perimeter of the support element 102; however, in other embodiments, the apertures 106 may be located at any position along the support element 102.

In other embodiments, the support element 102 is formed of thermoplastic injection molded material. In such an embodiment, the apertures 106 are formed in the support element 102 during injection molding. In still other embodiments, the support element 102 may be a combination of thermally-consolidated composite laminate or reinforced injection-molded thermoplastic. In such an embodiment, the thermally-consolidated composite laminate and the reinforced injection-molded thermoplastic are chemically compatible so that a homogenous chemical bond is formed between the portion of the support element 102 comprising the thermally-consolidated composite laminate and the portion of the support element 102 comprising the injection-molded thermoplastic.

In a typical embodiment, the reinforcing elements 104 are joined to the support element 102 via an integration process. Typically, the reinforcing members 104 are injection molded onto the support element 102. As illustrated in FIGS. 1-2, the reinforcing elements 104 are typically applied to the support element 102 in a symmetrical fashion; however in other embodiments, the reinforcing elements 104 may be applied in an asymmetrical fashion as dictated by design requirements. In a typical embodiment, the reinforcing elements 104 are constructed of a material that is chemically compatible with the support elements 102 so that a homogenous chemical bond is formed between the support element 102 and the reinforcing elements 104. During injection molding of the reinforcing elements 104, material comprising the reinforcing elements 104 flows through the apertures 106 formed in the support element 102. Such an arrangement facilitates bonding the support element 102 to the reinforcing elements 104 and enhances strength and rigidity of the arm rest support 100.

Still referring to FIGS. 1-2, in a typical embodiment, the reinforcing elements 104 are applied to a perimeter of the support element 102; however, in other embodiments, the reinforcing elements 104 could be applied to the support element 102 at any location. During application of the reinforcing elements 104, the support element 102 is installed into an injection molding tool. In various embodiments, the support element 102 may comprise a thermoplastic composite laminate material; however, in other embodiments, the support element 102 may comprise a thermoplastic injection molded panel. Exposed portions of the support element 102 are used to locate the support element 102 in the mold tool. Thermoplastic material is injection molded onto the support element 102 to form the reinforcing elements 104. In a typical embodiment, the reinforcing elements 104 are fiber reinforced such as, for example, carbon or glass fiber reinforced. During injection molding, the thermoplastic material flows through the apertures 106 formed in the support element 102 thereby enhancing increased strength and rigidity of the arm rest support 100. In a typical embodiment, the reinforcing elements 104 are formed of a material that is chemically-compatible with the support element 102 thereby facilitating formation of a chemically homogenous molecular bond between the support element 102 and the reinforcing elements 104.

Still referring to FIGS. 1-2, in embodiments where the support element 102 is formed of an injection molded thermoplastic material, use of two differing injection-molding processes to form the support element 102 and the reinforcing elements 104 facilitates utilization of materials of differing reinforcement types and levels for the support element 102 and the reinforcing elements 104. For example, in various embodiments, the reinforcing elements 104 may comprise a standard modulus and length reinforcing fiber having a tensile strength of approximately 530 ksi and a tensile modulus of approximately 34 MSI, and the support element 102 may comprise a high modulus long-fiber reinforcement having a tensile strength and a tensile modulus greater than the standard values listed above. Such an embodiment facilitates use of lower cost materials during production of the arm rest support 100.

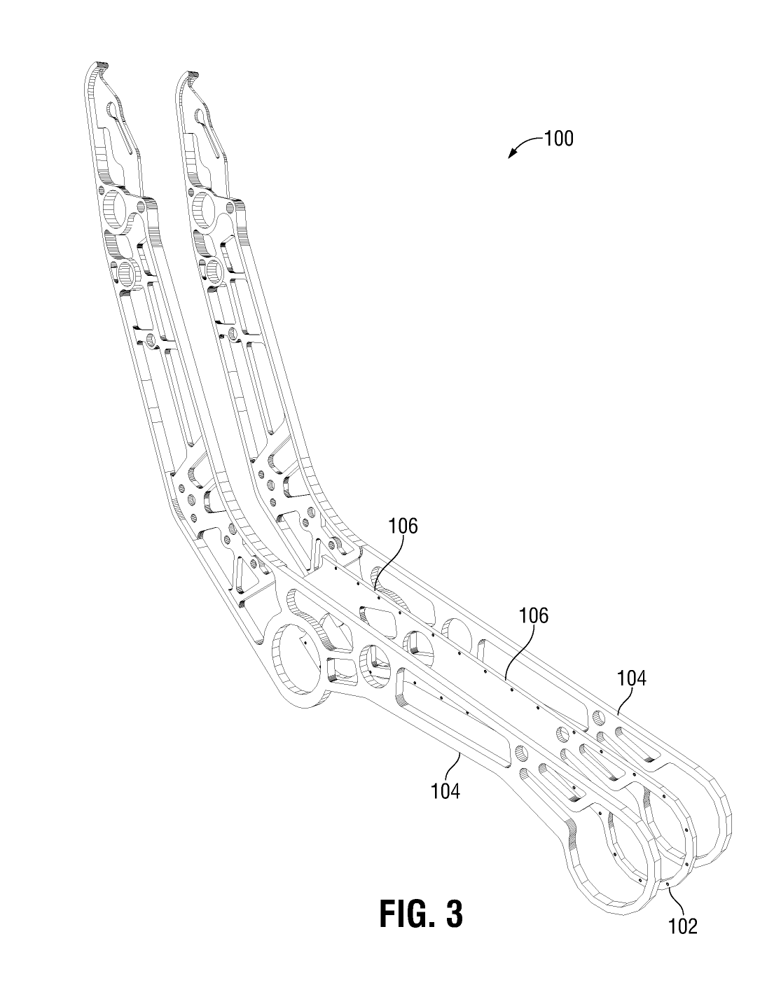

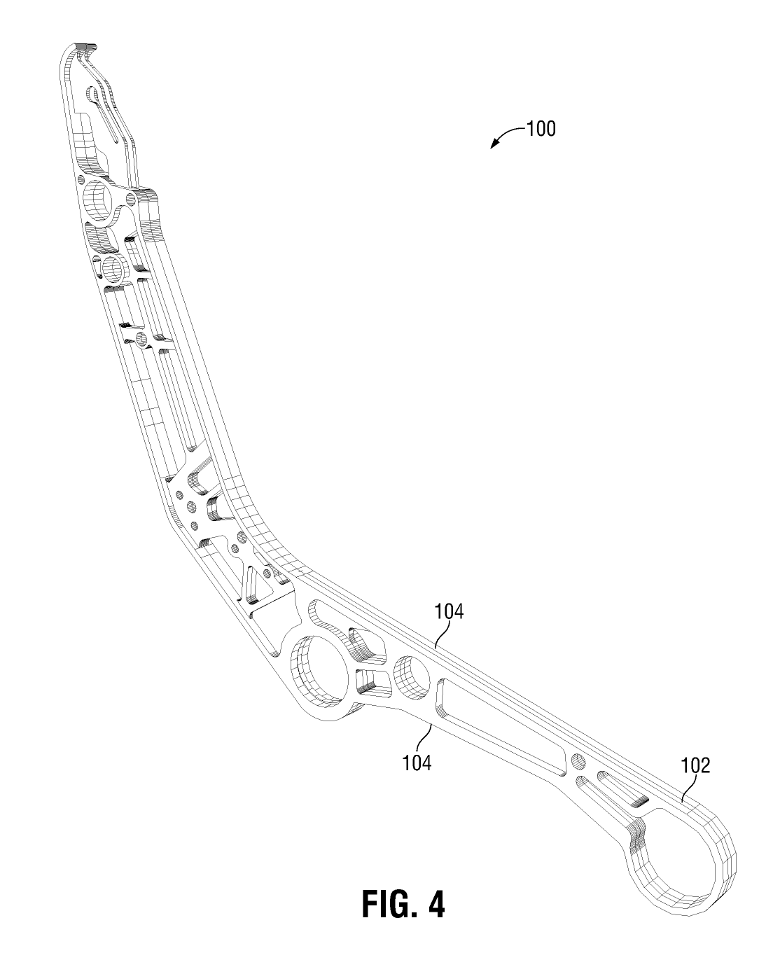

FIG. 3 is an exploded perspective view of an arm rest support 100′ having a partial-length support element 102′. FIG. 4 is a perspective view of the arm rest support 100′. Referring to FIGS. 3-4 collectively, the arm rest support 100′ includes a centrally-disposed support element 102′ integrally formed with a plurality of reinforcing elements 104 coupled thereto. In a typical embodiment, the support element 102′ extends partially along a length of the arm rest support 100′ as dictated by design requirements. In a typical embodiment, the support element 102′ includes a carbon or glass reinforced thermoplastic laminate material such as, for example, a thermally-consolidated composite material forming a composite structure. In some embodiments, the support element 102′ may be formed of the carbon reinforced thermoplastic material such as, for example, composite material and the reinforcing elements 104 may be molded onto the support element 102′. In a typical embodiment, the reinforcing elements 104 comprise a thermoplastic material with a resin compatible with the resin of the support element 102′. Typically, the thermoplastic of the reinforcing elements 104 are the same as the thermoplastic of the composite of the support element 102′ so that molding results in chemically-compatible homogenous connections.

Still referring to FIGS. 3-4 in various embodiments, the support element 102′ may be substantially flat and comprise a generally planar shape. In other embodiments, the support element 102′ may include a form such as, for example, a corrugation that is generally parallel to the long axis of the support element 102′ to enhance the strength of the support element 102′. A plurality of apertures 106 are formed in the support element 102′. The apertures 106′ are illustrated in FIG. 3 as being disposed along a perimeter of the support element 102′; however, in other embodiments, the apertures 106 may be located at any position along the support element 102′.

In other embodiments, the support element 102′ is formed of thermoplastic injection molded material. In such an embodiment, the apertures 106 are formed in the support element 102′ during injection molding. In still other embodiments, the support element 102′ may be a combination of thermally-consolidated composite laminate or reinforced injection-molded thermoplastic. In such an embodiment, the thermally-consolidated composite laminate and the reinforced injection-molded thermoplastic are chemically compatible so that a homogenous chemical bond is formed between the portion of the support element 102′ comprising the thermally-consolidated composite laminate and the portion of the support element 102′ comprising the injection-molded thermoplastic.

Still referring to FIGS. 3-4, the reinforcing elements 104 are joined to the support element 102′ in a similar manner as discussed above with respect to FIGS. 1-2. During application of the reinforcing elements 104, the support element 102′ is installed into an injection molding tool. In various embodiments, the support element 102′ may comprise a thermoplastic composite laminate material; however, in other embodiments, the support element 102′ may comprise a thermoplastic injection molded panel. Exposed portions of the support element 102′ are used to locate the support element 102′ in the mold tool. Thermoplastic material is injection molded onto the support element 102′ to form the reinforcing elements 104. In a typical embodiment, the reinforcing elements 104 are fiber reinforced such as, for example, carbon or glass fiber reinforced. During injection molding, the thermoplastic material flows through the apertures 106 formed in the support element 102′ thereby enhancing strength and rigidity of the arm rest support 100. In a typical embodiment, the reinforcing elements 104 are formed of a material that is chemically-compatible with the support element 102′ thereby facilitating formation of a chemically homogenous molecular bond between the support element 102′ and the reinforcing elements 104.

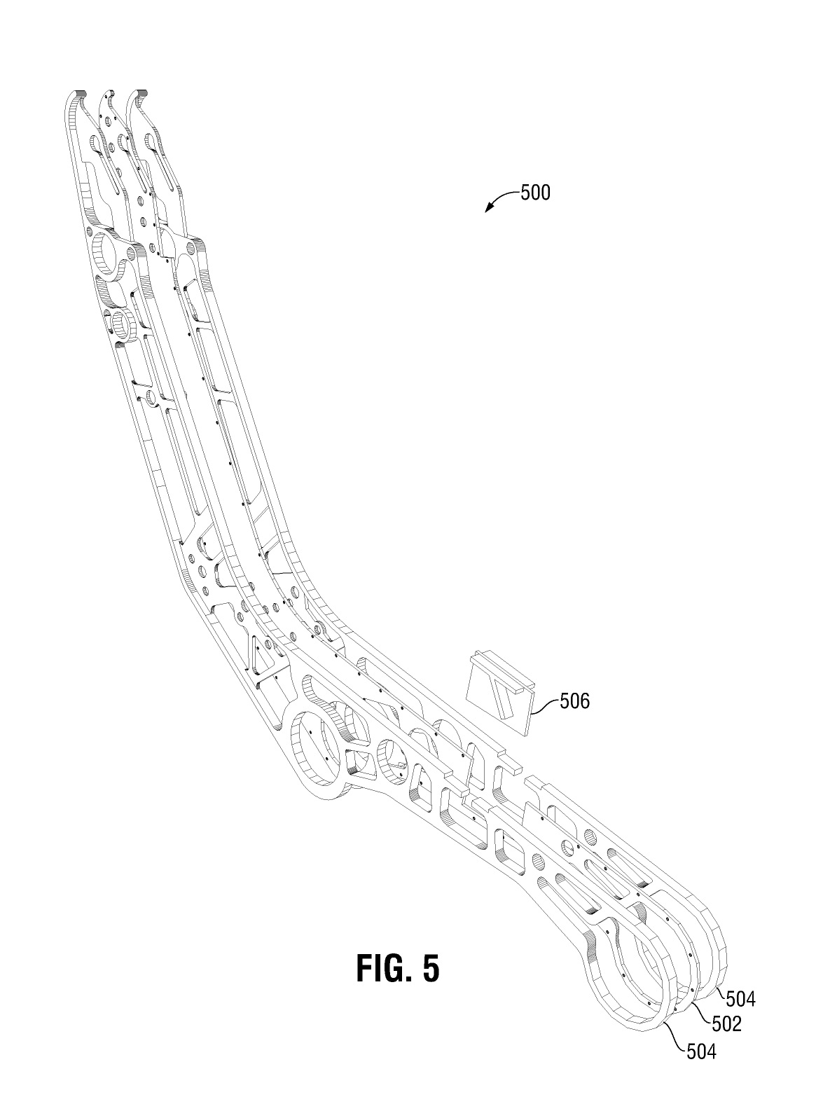

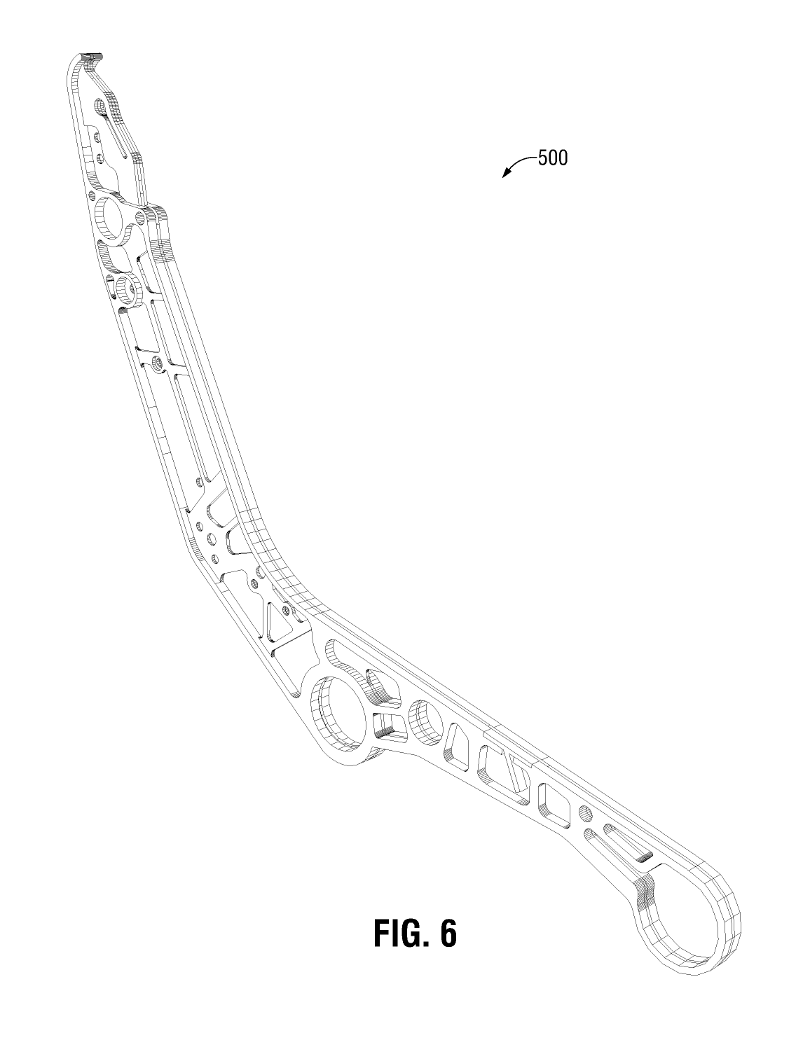

FIG. 5 is an exploded perspective view of the arm rest support 500 having a homogenous failure module (“HFM”) incorporated therewith. FIG. 6 is a perspective view of the arm rest support 500. The HFM 506 is disposed in the support element 502 and the reinforcing elements 504 at a specified location so as to induce failure of the arm rest support 500 at a desired location. The HFM 506 includes a carbon-reinforced structure. The HFM 506 is designed to fail based upon the arm rest support's 500 specific application. All elements of the environment of use are considered, along with the tolerable end result in the case of a system failure. The HFM 506 is the initial mechanism to allow stress to overcome, for example, the arm rest support 500 in a controlled manner. Once the HFM 506 fails, the particular failure precipitates the next failure in the system. The HFM 506 will fail in a specific manner which in turn applies loads (stress) to a location in a specific manner, causing the system to fail at that predefined position with an end result (condition) that does not create an object of lethality or interference to movement or egress. In various embodiments, the HFM 506 may be used in conjunction with the arm rest support 100 or the arm rest support 100′.

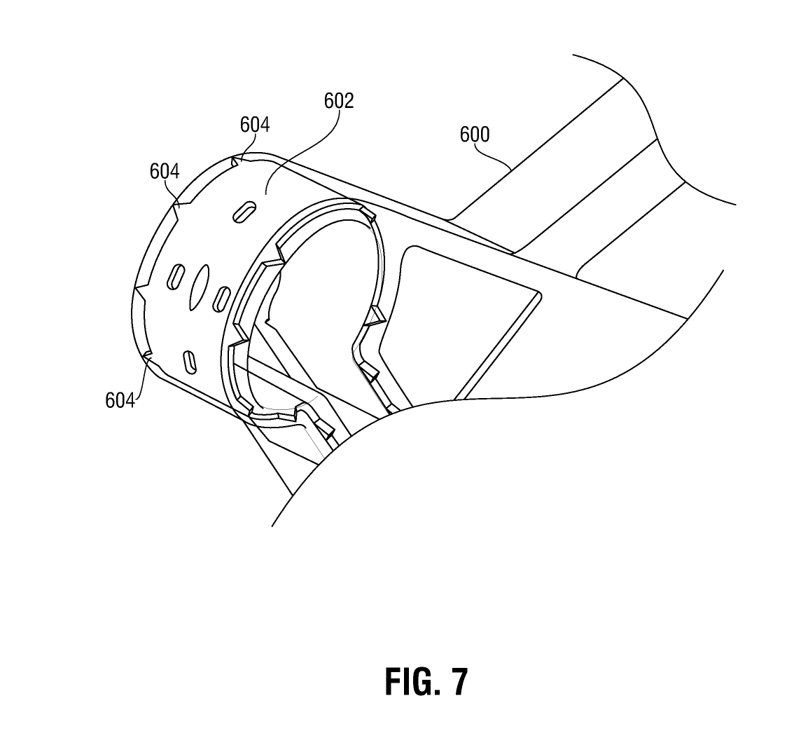

FIG. 7 is a partial perspective view of a thermoplastic support element 600 with an integral thermoplastic positioning system (ITPS) 602 embedded therein. For purposes of illustration, FIG. 7 will be described herein relative to FIGS. 1-6. The ITPS 602 includes a latticework having a plurality of spires or projections 604 extending outwardly distally. In a typical embodiment, the spires 604 act to hold the support element 600 in position during molding of the reinforcing elements 104 and typically will fix a position of the support element 600 in three dimensions. In various embodiments, the ITPS 602 may be used in conjunction with the support element 102, as depicted in FIGS. 1-2, the support element 102′, as depicted in FIGS. 3-4, or the support element 502 as depicted in FIGS. 5-6.

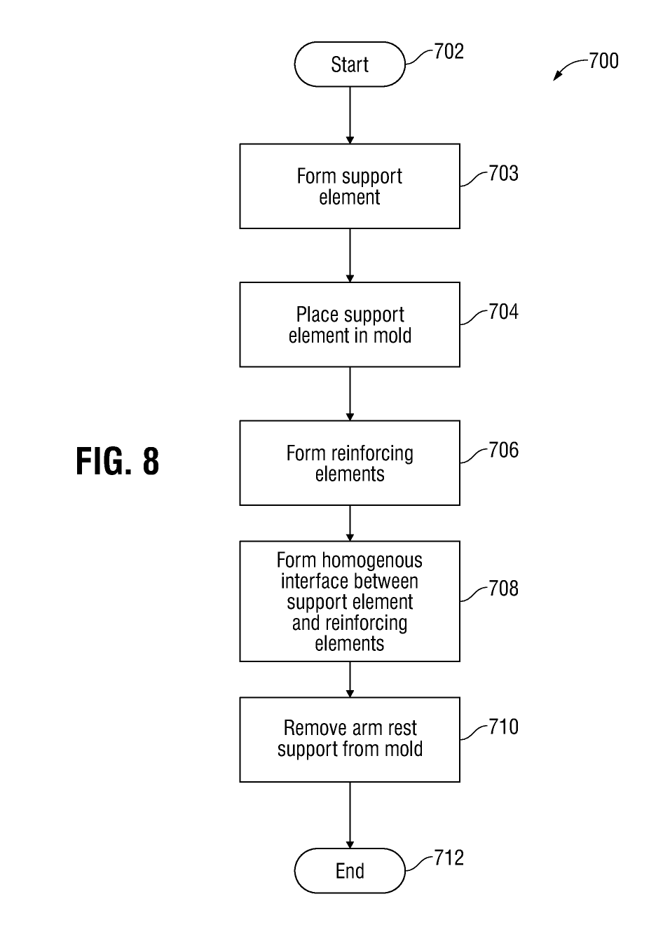

FIG. 8 is a flow diagram of a process 700 for forming an arm rest support. For purposes of illustration, FIG. 8 will be described herein relative to FIGS. 1-7. The process starts a step 702. At step 703, the support element 102 is formed. In a typical embodiment, the support element 102 may be formed of a composite material or a reinforced thermoplastic material. In various embodiments, step 703 includes forming the support element 102 via one or more molding steps. For example, in various embodiments, step 703 may include forming the support element 102 with various reinforcements constructed of a first carbon material. At step 704 the support element 102 is placed in a mold. During step 704, an ITPS may be utilized to position the support elements 102. At step 706, thermoplastic material is injection molded onto the support element 102 to form the reinforcing elements 104. The thermoplastic material penetrates the apertures 106 formed in the support element 102. At step 708, a chemically compatible homogenous bond is formed between the support element 102 and the thermoplastic material of the reinforcing elements 104 at all contact points. Formation of the chemically compatible homogenous bond facilitates creation of the homogenous single-piece arm rest support 100. In various embodiments, the reinforcing elements 104 are formed of a second carbon material. In a typical embodiment, use of the first carbon material and the second carbon material allows the arm rest support to be formed with multiple strength regions. At step 710, the arm rest support 100 is removed from the mold. The process ends at step 712.

The advantages of the present invention will be apparent to those skilled in the art. In a typical embodiment, the arm rest support 100 provides increased load bearing capacity facilitated by the integrally formed reinforcing elements 104 being integrated into the support element 102. Additionally, the arm rest support 100 may decrease the physical dimensions of arm-rest supports presently in use by virtue of using a plurality of high strength-to-weight materials. When utilized in conjunction with the HFM 602, the arm rest support 100 will fail in a predictable repeatable manner responsive to application of defined loading.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. An arm rest support comprising:
a thermoplastic support element, the thermoplastic support element having a plurality of apertures formed therethrough;
a reinforcing element disposed on a generally planar surface of the thermoplastic support element, the reinforcing element being chemically compatible with the thermoplastic support element and surrounding a perimeter of the thermoplastic support element; and
wherein, the plurality of apertures allow thermoplastic material to flow therethrough thereby facilitating creation of a homogeneous chemical bond between the support element and the reinforcing element.

2. The arm rest support of claim 1, comprising an integral thermoplastic positioning system coupled to the thermoplastic support element.

3. The arm rest support of claim 2, wherein the integral thermoplastic positioning system comprises a plurality of spire elements protruding from the thermoplastic support element.

4. The arm rest support of claim 3, wherein the plurality of spire elements facilitate proper placement of the reinforcing element relative to the thermoplastic support element.

5. The arm rest support of claim 1, wherein a first reinforcing element is disposed on a first generally planar surface of the thermoplastic support element and a second reinforcing element is disposed on a second generally planar surface of the thermoplastic support element.

6. The arm rest support of claim 5, wherein the thermoplastic support element is centrally located between the first reinforcing element and the second reinforcing element.

7. The arm rest support of claim 1, wherein the thermoplastic support element is injection molded.

8. The arm rest support of claim 1, wherein the thermoplastic support element is a combination of injection molded material and composite material.

9. The arm rest support of claim 1, comprising a homogenous failure module disposed in the thermoplastic support element.

10. The arm rest support of claim 1, wherein the thermoplastic support element comprises a high modulus material and the reinforcing element comprises a standard modulus material.

11. The arm rest support of claim 1, wherein the thermoplastic support element is coextensive with the reinforcing element.

12. A method of forming a thermoplastic arm rest support, the method comprising:
forming a thermoplastic support element, the thermoplastic support element having a plurality of apertures formed therein;
arranging the thermoplastic support element in a mold;
molding a reinforcing element to a generally planar surface of the thermoplastic support element;
flowing thermoplastic material through the plurality of apertures; and
creating a homogeneous chemical bond between the thermoplastic support element and the reinforcing element.

13. The method of claim 12, wherein the molding comprises molding a first reinforcing element to a first generally planar surface of the thermoplastic support element and molding a second reinforcing element to a second generally planar surface of the thermoplastic support element.

14. The method of claim 12, wherein the arranging comprises positioning the thermoplastic support element in the mold utilizing an integral thermoplastic positioning system.

15. The method of claim 12, wherein the molding comprises forming the reinforcing element to be coextensive with the thermoplastic support element.

16. The method of claim 12, comprising injection molding the thermoplastic support element.

17. The method of claim 12, comprising incorporating a homogeneous failure module into the thermoplastic support element.

18. The method of claim 12 comprising forming the thermoplastic support element of a high modulus material and forming the reinforcing element of a standard modulus material.

19. The method of claim 12, comprising forming the thermoplastic support element of a combination of injection molded and composite material.
